(19) United States
(12) Patent Application Publication
(10) Pub. No.: US 2005/0184863 A1
(43) Pub. Date: Aug. 25, 2005

(54) Interactive automotive pilot light

(76) Inventor: John Robert Demarest, Natrona Heights PA, PA (US)

Correspondence Address: John R. Demarest, 1208 Cambridge Street, Natrona Heights, PA, 15065, US

(21) Appl. No.: 10/708,298

(22) Filed: Feb. 23, 2004

(51) Int. Cl. B60Q 1/50

(52) U.S. Cl. 340/467; 340/470

(57) ABSTRACT

This light emitting apparatus which comprises a light emitting section whose color changes by driver acceleration/deceleration. Designed to mirror the tachometer activity in passenger vehicles, values at idle rpm would emit an amber glow. Values above this would be green lit and increase in intensity in concert with rpm value. Values which would be considered the red line extreme (as indicated on the cabins tachometer) would be red lit. In ideal application, these apparatuses would be clearly visible at the front and rear of the vehicle. An additional application of this engine running light would be a driver accessible manual override for the green light. Similar in design of a timed rear window defogger, this override button when pressed by the driver would cause the green light to blink for a brief prescribed duration then revert to pilot light capacity. This could be referred to as the let it pass button. For night driving, if you were to see a car in your rear view mirror with a green light glowing too intensely for comfort and you are observing the posted speed limit, you push this (let it pass) button and continue driving in accord with prescribed law. Conversely, should you see in your rear view mirror a pilot light approaching glowing red, you may chose to pull over. Abstract of Disclosure. While this invention has been described in connection with one or more embodiments, it should be understood that this invention is not limited to those embodiments. This invention covers all alternatives, modifications, and equivalents, as may be included within the spirit of the intended

### DETAILED DESCRIPTION

A light emitting display which indicates tachometer values in an externally visible apparatus. An automobile whose engine is running but idle will display the amber yellow color. When driver accelerates this pilot light glows green.

This concept inspired by the status lighht found on computer monitors. Expanding on this concept, the red light could represent near to full throttle acceleration. An additional serendipitous application is the capability to now create a blinking green light which would derve as a user selected option which acknowledges (via this blinking green light) you are anticipating someone's desire to pass you. One final benefit to this pilot light/engine running light concept is that if it's not lit—the engine has stalled.

1. This invention serves to marry tachometer rpm values with an externally viewable status light.

2. This invention serves to provide a greater understanding of driver intent via this light emitting display.

3. Having a yellow, then green, then (at the extreme to mirror the tachometer) red light emitting display would provide some useful information for fellow drivers.

4. The addition of a driver activated self timed blink option for the pilot light would provide a safe and effective means for acknowledging those wanting to pass.
